(19) United States
(12) Patent Application Publication
(10) Pub. No.: US 2019/0271268 A1
(43) Pub. Date: Sep. 5, 2019

(54) Turbine Engine With Rotating Detonation Combustion System

(71) Applicant: General Electric Company, Schenectady, NY (US)

(72) Inventors: Arthur Wesley Johnson, Cincinnati, OH (US); Steven Clayton Vise, Loveland, OH (US); Clayton Stuart Cooper, Loveland, OH (US); Joseph Zelina, Waynesville, OH (US); Sibtosh Pal, Mason, OH (US)

(21) Appl. No.: 15/909,196

(22) Filed: Mar. 1, 2018

(51) Int. Cl. F02C 7/22; F23R 3/28; F23R 3/10; F01D 9/02; F02C 3/08

(52) U.S. Cl. CPC F02C 7/222; F23R 3/286; F02C 3/14; F01D 9/02; F02C 3/08; F23R 3/10

(57) ABSTRACT

A turbine engine including a compressor rotor and a rotating detonation combustion (RDC) system. The compressor rotor includes a compressor airfoil defining a trailing edge disposed within a core flowpath of the turbine engine. The core flowpath defines a radial distance between an outer radius and an inner radius at the compressor rotor. The RDC system includes an outer wall and an inner wall each extended along a lengthwise direction and defining a detonation chamber therebetween. The RDC system further includes a strut defining a nozzle assembly and a fuel injection opening providing a flow of fuel to the detonation chamber. The compressor rotor provides a flow of oxidizer in direct fluid communication to the nozzle assembly of the RDC system.

### FIELD

The present subject matter relates generally to gas turbine engines and systems of continuous detonation.

### BACKGROUND

Gas turbine engine designers and manufacturers are generally challenged to improve fuel consumption, increase thrust output, and reduce weight to improve engine efficiency and performance. Known gas turbine engines generally define a Brayton Cycle and include deflagrative combustion systems to burn a fuel/air mixture and produce combustion gas products which travel at relatively slow rates and constant pressure within a combustion chamber. Such combustion systems generally include vane structures at an exit of a compressor section or an inlet of a turbine section (or an exit of a combustion section) to condition a flow of air to the combustion system to improve thermodynamic efficiency and combustor/engine operability and performance (e.g., mitigate lean blow out, reduce combustion hot spots, improve radial flow velocity of gases into and exiting the combustion chamber, etc.). However, these structures increase engine weight, such as via increased lengthwise dimensions and increased part quantities. Still further, these structures may limit engine reliability, such as to require maintenance (e.g., turbine nozzles or vanes). Nonetheless, these structures are generally known as necessary to produce gas turbine engines of a level of performance and operability required in the art and throughout the industry.

As such, there is a need for gas turbine engines that further improve fuel consumption, increase thrust output, and reduce weight to further improve engine efficiency and performance.

### BRIEF DESCRIPTION

Aspects and advantages of the invention will be set forth in part in the following description, or may be obvious from the description, or may be learned through practice of the invention.

The present disclosure is directed to a turbine engine including a compressor rotor and a rotating detonation combustion (RDC) system. The compressor rotor includes a compressor airfoil defining a trailing edge disposed within a core flowpath of the turbine engine. The core flowpath defines a radial distance between an outer radius and an inner radius at the compressor rotor. The RDC system includes an outer wall and an inner wall each extended along a lengthwise direction and defining a detonation chamber therebetween. The RDC system further includes a strut defining a nozzle assembly and a fuel injection opening providing a flow of fuel to the detonation chamber. The compressor rotor provides a flow of oxidizer in direct fluid communication to the nozzle assembly of the RDC system.

In various embodiments, the fuel injection opening is defined at a first lengthwise distance from the trailing edge of the compressor airfoil equal to or less than approximately nine times the radial distance of the core flowpath. In one embodiment, the strut of the RDC system defines an upstream end defined at a second lengthwise distance less than the first lengthwise distance.

In one embodiment, the radial distance of the core flowpath is defined approximately at the trailing edge or downstream of the compressor airfoil.

In another embodiment, the compressor rotor defines a downstream-most rotor of a compressor section of the turbine engine proximate to the RDC system.

In various embodiments, the strut is disposed at an acute nozzle angle relative to a reference radial plane extended from an axial centerline of the turbine engine. In one embodiment, the nozzle angle is between approximately zero degrees and approximately 85 degrees relative to the axial centerline of the turbine engine. In still various embodiments, the compressor airfoil defines an exit angle relative to the axial centerline of the turbine engine, and wherein a sum of the exit angle and the nozzle angle is between approximately zero degrees and approximately 85 degrees. In one embodiment, the compressor airfoil defines the exit angle within approximately 20 degrees of the nozzle angle.

In various embodiments, the turbine engine further includes a pressure vessel surrounding the outer wall and the inner wall of the RDC system. A cooling passage is defined between the pressure vessel and the RDC system. In one embodiment, the pressure vessel comprises an outer vessel wall and an inner vessel wall. The outer vessel wall and the inner vessel wall are each extended along the lengthwise direction around the outer wall and the inner wall of the RDC system. In another embodiment, the cooling passage is in fluid communication with the core flowpath between the trailing edge of the compressor airfoil and the strut, and a flow of oxidizer is provided from the core flowpath and the cooling passage via an opening in at least one of the outer wall or the inner wall.

In various embodiments, the turbine engine further includes a turbine rotor including a turbine airfoil disposed downstream of the RDC system in direct fluid communication with the detonation chamber. In one embodiment, the core flowpath defines a turbine radial distance at the turbine rotor between an outer turbine radius at the turbine rotor and an inner turbine radius at the turbine rotor. The leading edge of the turbine airfoil defines a turbine lengthwise distance from the detonation chamber exit equal to or less than approximately five times the turbine radial distance of the core flowpath. In another embodiment, the RDC system defines a radial gap between the outer wall and the inner wall, and the strut defines a downstream end defined adjacent to the detonation chamber. The RDC system defines a detonation chamber length between the downstream end and the detonation chamber exit equal to or less than approximately five times the radial gap. In still another embodiment, the trailing edge of the compressor rotor and the leading edge of the turbine rotor define a lengthwise distance equal to or less than approximately nine times the radial gap. In still yet another embodiment, the turbine airfoil of the turbine rotor defines a turbine exit angle relative to a reference radial plane extended from an axial centerline of the turbine engine. The turbine exit angle is between approximately zero and approximately 85 degrees. In another embodiment, the turbine exit angle is within approximately 20 degrees of a nozzle angle relative to the reference radial plane.

In various embodiments, the turbine engine further includes a guide vane disposed between the compressor rotor and the RDC system along the lengthwise direction. The guide vane includes a fin extended at least partially along a circumferential direction to dispose a flow of oxidizer to the RDC system. In one embodiment, one or more of the fins is disposed at an acute angle relative to the lengthwise direction such as to dispose a flow of oxidizer to a cooling passage defined at least partially around the RDC system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is an exemplary schematic embodiment of a gas turbine engine including an exemplary embodiment of a rotating detonation combustion system according to an aspect of the present disclosure;

FIG. 2 is a cross sectional view of an exemplary embodiment of a compressor rotor and the rotating detonation combustion system of the engine of FIG. 1;

FIG. 3 is an exemplary embodiment of a detonation chamber of a rotating detonation combustion system generally in accordance with an embodiment of the present disclosure generally provided in FIG. 2;

FIG. 4 is an exemplary radial view of a compressor rotor and a rotating detonation combustion system of the engine of FIG. 1;

FIGS. 5-6 are exemplary embodiments of a compressor rotor, a rotating detonation combustion system, and a turbine rotor of the engine of FIG. 1; and

FIG. 7 is another exemplary embodiment of a compressor rotor and a rotating detonation combustion system of the engine of FIG. 1.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “forward” and “aft” refer to relative positions within a propulsion system or vehicle, and refer to the normal operational attitude of the propulsion system or vehicle. For example, with regard to a propulsion system, forward refers to a position closer to a propulsion system inlet and aft refers to a position closer to a propulsion system nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Embodiments of a gas turbine engine including a rotating detonation combustion (RDC) system are generally provided. The embodiments provided herein may improve engine efficiency and performance via the pressure-gain detonation combustion systems generally shown and described herein relative to a compressor section and a turbine section. The embodiments of the engine generally shown and described herein may improve fuel consumption, increase thrust output, and decrease pressure losses. The embodiments generally provided may further reduce engine complexity, thereby improving maintainability and reduce part quantity and weight, thereby improving cost of operation and reliability. The embodiments of the engine provided herein generally obviate one or more of a diffuser dump region, a pre-diffuser or compressor guide vane structure, or a turbine nozzle or vane assembly generally provided in known gas turbine engines. For example, the embodiments of the engine generally provided herein include the RDC system as providing a fuel injection structure that further conditions, guides, or otherwise orients a flow of oxidizer from a compressor section to a detonation chamber. As another example, the fuel injection structure of the RDC system may further provide a bulk swirl of a flow of detonation gases from the detonation chamber to a turbine section such as to obviate a turbine nozzle or vane assembly upstream of a turbine rotor. As such, a lengthwise dimension of the gas turbine engine may be reduced such as to further reduce weight, increase thrust output, decrease pressure losses, improve fuel consumption, and enable integration of higher thrust gas turbine engines into smaller apparatuses.

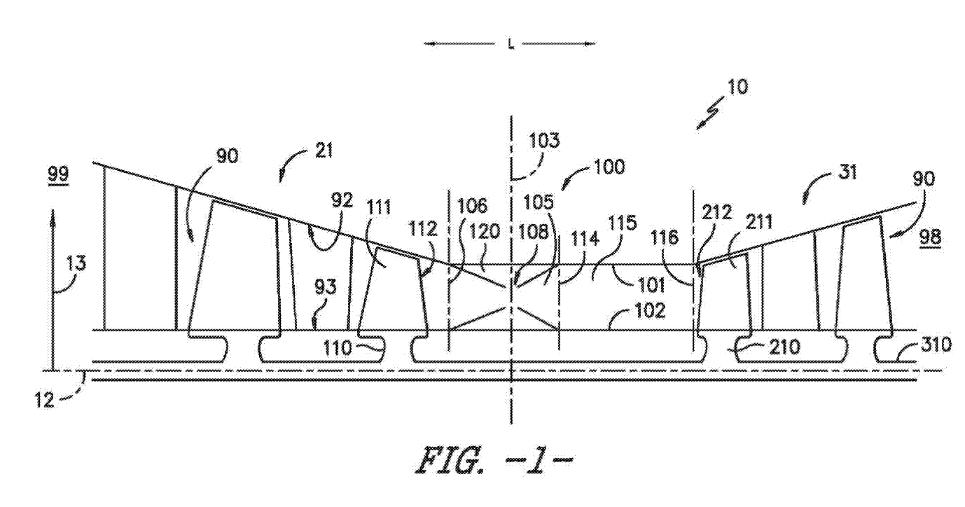

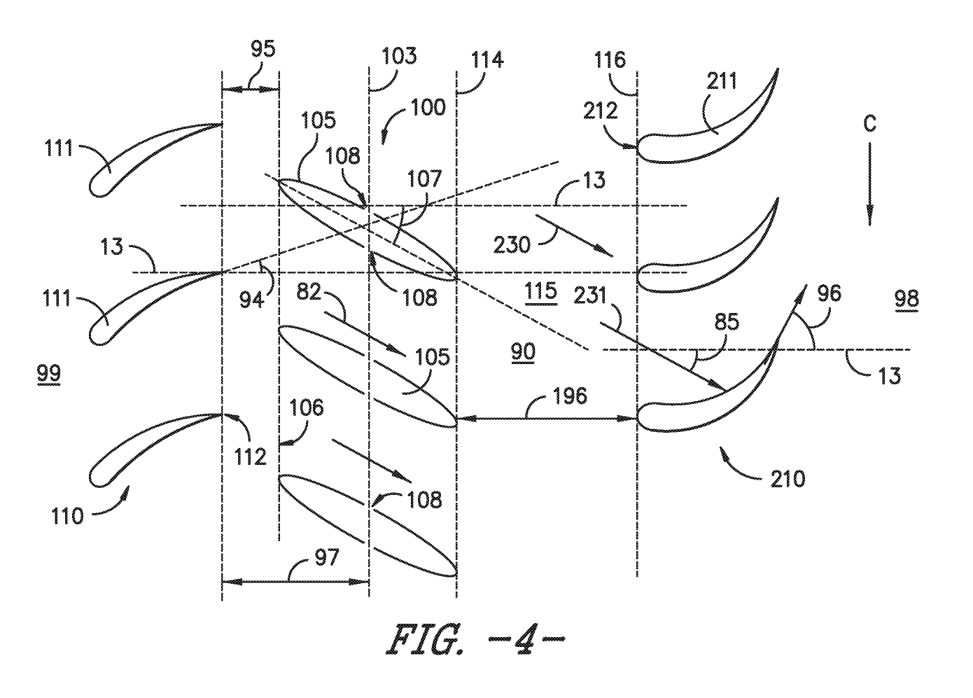

Referring now to FIG. 1, an exemplary schematic embodiment of a gas turbine engine 10 including an exemplary embodiment of a rotating detonation combustion (RDC) system 100 according to an aspect of the present disclosure is generally provided. The engine 10 defines a lengthwise direction L and a reference axial centerline 12 extended through the engine 10 along the lengthwise direction L. The engine 10 further defines a radial plane 13 extended from the axial centerline 12. The engine 10 further defines a circumferential direction C around the axial centerline 12 (FIG. 4). The engine 10 further defines a reference upstream end 99 and a reference downstream end 98, in which fluid flows through the engine 10 generally from the upstream end 99 toward the downstream end 98.

The engine 10 may generally define a turbofan, a turboprop, turbojet, or a turboshaft engine configuration, including marine and industrial gas turbine engines and auxiliary power units. The engine 10 includes a compressor rotor 110 and a turbine rotor 210 each coupled together in rotational dependency via a driveshaft 310. The compressor rotor 110, the turbine rotor 210, and the driveshaft 310 may together define a spool of the engine 10. For example, the spool may be a high pressure (HP) spool of the engine 10. The compressor rotor 110 described herein defines a downstream-most rotor of a compressor section 21 of the engine 10. For example, the exemplary compressor rotor 110 defined herein is most proximate to the RDC system 100 relative to one or more other rotors further upstream within the compressor section 21. Still further, the turbine rotor 210 described herein defines an upstream-most rotor of a turbine section 31 of the engine 10. For example, the exemplary turbine rotor 210 defined herein is most proximate to the RDC system 100 relative to one or more other rotors further downstream within the turbine section 31.

The engine 10 generally provided in FIG. 1 is provided by way of example only. In certain exemplary embodiments, the engine 10 may include any suitable number of compressors within the compressor section 21, any suitable number of turbines within the turbine section 31, and any number of shafts to mechanically link one or more compressors to one or more turbines. Still further, the compressor section 21 may further include a fan rotor, or plurality thereof, coupled to one or more turbines of the turbine section 31. In various embodiments, the fan rotor may be a variable pitch fan, a fixed pitch fan, a ducted fan, or an un-ducted fan, or any other suitable configuration. In still various embodiments, the engine 10 may further include a speed change device, such as a reduction gearbox, disposed between the turbine section 31 and one or more rotors of the compressor section 21, such as to define a rotational speed of one or more rotors of the turbine section 31 as different from 1:1 proportional to one or more rotors of the compressor section 21.

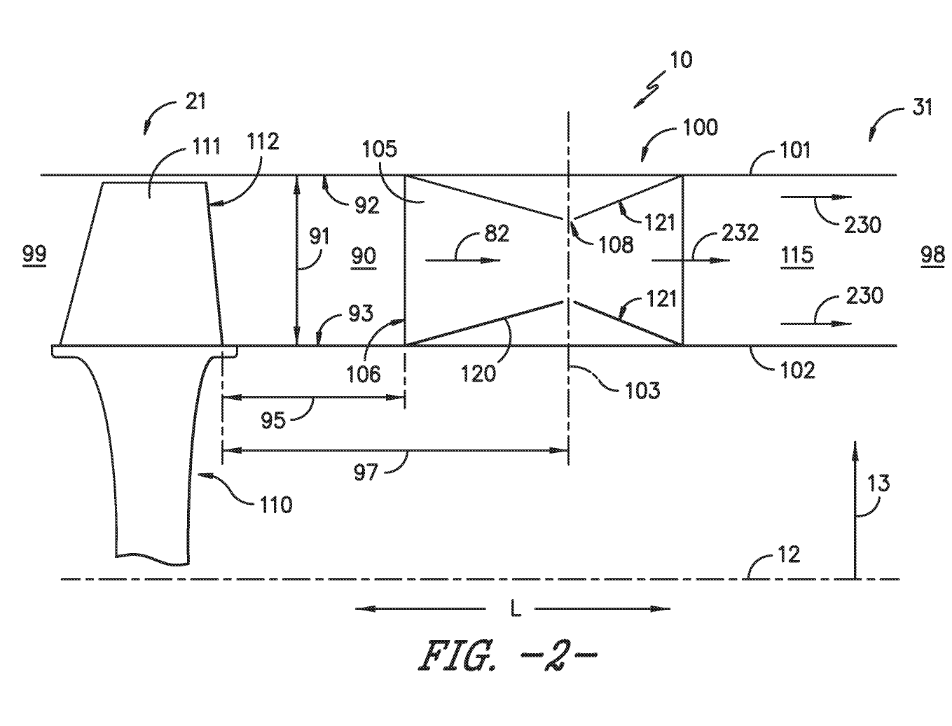

Referring now to FIG. 2, a cross sectional view of an exemplary embodiment of the compressor rotor 110 and the RDC system 100 of the engine 10 of FIG. 1 is generally provided. The compressor rotor 110 includes a compressor airfoil 111 defining a trailing edge 112 disposed within a core flowpath 90 of the engine 10. The core flowpath 90 is defined within engine 10 through which oxidizer, such as air, flows and is compressed across one or more compressors of the compressor section 21 (FIG. 1). The core flowpath 90 defines a radial distance 91 between an outer radius 92 and an inner radius 93 at the compressor rotor 110. More specifically, the radial distance 91 of the core flowpath 90 is defined at the trailing edge 112 of the downstream-most compressor rotor 110.

The RDC system 100 includes a nozzle assembly 120 disposed downstream of the compressor rotor 110. For example, the nozzle assembly 120 of the RDC system 100 is disposed in direct fluid communication downstream of the compressor rotor 110. As another example, the nozzle assembly 120 of the RDC system 100 is defined downstream of the compressor rotor 110 such as to obviate a diffuser dump region relative to conventional gas turbine engines. In still various embodiments, the nozzle assembly 120 defines a compressor exit guide vane and/or pre-diffuser and a fuel injection system providing a fuel/oxidizer mixture to a downstream detonation chamber 115.

The RDC system 100 includes an outer wall 101 and an inner wall 102 each extended along the lengthwise direction L. The detonation chamber 115 is defined between the outer wall 101 and the inner wall 102. The nozzle assembly 120 includes a nozzle wall 121. In various embodiments the nozzle wall 121 defines a convergent-divergent nozzle, such as defining a decreasing cross sectional area toward the upstream end of the RDC system followed by an increasing cross sectional area toward the downstream end of the RDC system proximate to the detonation chamber 115. In one embodiment, the nozzle wall 121 is defined circumferentially around the axial centerline 12 of the engine 10. In another embodiment, the RDC system 100 defines a plurality of the nozzle assembly 120 including a plurality of the nozzle wall 121 each defining an orifice through which oxidizer or fuel/oxidizer mixture flows into the detonation chamber 115.

The nozzle assembly 120 further includes a strut 105 defined along the radial plane 13 extended from the axial centerline 12. In various embodiments, the strut 105 defines a plurality of vanes disposed in circumferential arrangement through the core flowpath 90. The nozzle assembly 120 further defines a fuel injection opening 108 through which a flow of liquid or gaseous fuel (or combinations thereof) mixes with a flow of oxidizer, such as shown schematically by arrows 82, from the compressor section 21 (FIG. 1). The fuel/oxidizer mixture (shown schematically by arrows 232) flows to the detonation chamber 115. In still various embodiments, the fuel injection opening 108 is defined through the strut 105, the nozzle wall 121, or both.

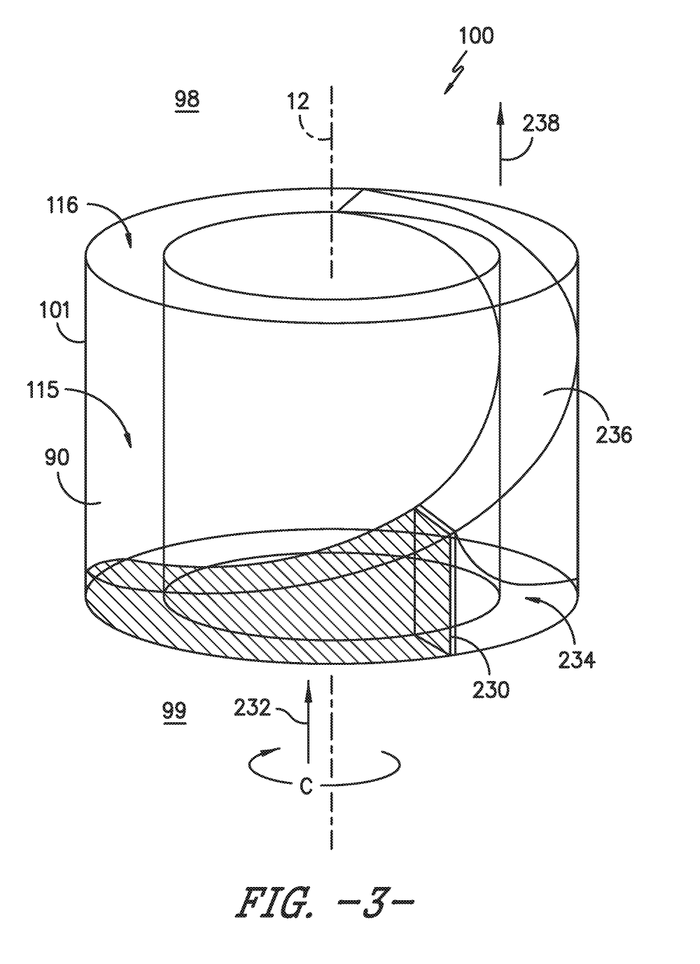

In various embodiments, the strut 105 defines, at least in part, a flowpath through the nozzle assembly 120 at which the flow of oxidizer 82 mixes with a flow of fuel. In one embodiment, the strut 105 defines, at least in part, a contoured flowpath structure such as to guide or orient the flow of oxidizer 82, the flow of fuel, and/or the flow of fuel/oxidizer mixture 232 along the circumferential direction C (FIG. 3). In another embodiment, the strut 105 defines a fuel passage or cavity through which a flow of fuel is provided from a fuel system to the detonation chamber 115 via the strut 105 of the nozzle assembly 120.

Referring briefly to FIG. 3, providing a perspective view of the detonation chamber 115 (without the nozzle assembly 120), it will be appreciated that the RDC system 100 generates a detonation wave 230 during operation. The detonation wave 230 travels in the circumferential direction C of the RDC system 100 consuming an incoming fuel/oxidizer mixture 232 and providing a high pressure region 234 within an expansion region 236 of the combustion. A burned fuel/oxidizer mixture 238 (i.e., combustion products) exits the detonation chamber 115 and is exhausted.

More particularly, it will be appreciated that the RDC system 100 is of a detonation-type combustor, deriving energy from the continuous detonation wave 230. For a detonation combustor, such as the RDC system 100 disclosed herein, the combustion of the fuel/oxidizer mixture 232 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction and convection. By contrast, with a detonation combustor, the detonation is a shock induced flame, which results in the coupling of a reaction zone and a shockwave. The shockwave compresses and heats the fresh fuel/oxidizer mixture 232, increasing such fuel/oxidizer mixture 232 above a self-ignition point. On the other side, energy released by the combustion contributes to the propagation of the detonation shockwave 230. Further, with continuous detonation, the detonation wave 230 propagates around the combustion chamber 115 in a continuous manner, operating at a relatively high frequency. Additionally, the detonation wave 230 may be such that an average pressure inside the combustion chamber 115 is higher than an average pressure within typical combustion systems (i.e., deflagration combustion systems). Accordingly, the region 234 behind the detonation wave 230 has very high pressures.

Referring back to FIG. 2, a fuel injection radial reference plane 103 is defined through the fuel injection opening 108. The fuel injection opening 108 is defined through the fuel injection radial reference plane 103 at a first lengthwise distance 97 from the trailing edge 112 of the compressor airfoil 11 equal to or less than approximately nine times the radial distance 91 of the core flowpath 90. In one embodiment, the first lengthwise distance 97 is equal to or less than approximately seven times the radial distance 91 of the core flowpath 90. In another embodiment, the first lengthwise distance 97 is equal to five times the radial distance 91 of the core flowpath 90.

It should be appreciated that in one embodiment, the first lengthwise distance 97 is generally defined to a center point of the fuel injection opening 108, such as shown schematically via fuel injection reference plane 103. However, in other embodiments, a difference in distance from a center point of the fuel injection opening 108 to a surrounding wall defining the fuel injection opening 108 is small enough such as to be within the approximation language as used herein. As such, various embodiments of the first lengthwise distance 97 may alternatively be defined to the fuel injection reference plane 103 defined at a wall defining the fuel injection opening 108 (i.e., a radius from a center point of the fuel injection opening 108, or a major axis or a minor axis from a center point of the fuel injection opening 108, etc., to a surrounding wall), at a centerline, center point, or center plane of the fuel injection opening 108, or combinations thereof.

It should further be appreciated that in various embodiments of the engine 10, the RDC system 100 may define one or more fuel injection openings 108 at a plurality of locations along the lengthwise direction L. As such, it should be appreciated that the first lengthwise direction L is generally understood as relative to a forward or upstream-most fuel injection opening 108 along the lengthwise direction L relative to the trailing edge 112 of the compressor airfoil 111.

In still various embodiments of the RDC system 100, the strut 105 of the nozzle assembly 120 defines an upstream end 106 defined at a second lengthwise distance 95 less than the first lengthwise distance 97. The second lengthwise distance 95 is defined from the trailing edge 112 of the compressor rotor 110 to the upstream end 106 of the strut 105 of the RDC system 100.

Referring now to FIG. 4, an exemplary radial view of the compressor rotor 110 and the RDC system 100 is generally provided. The exemplary embodiment provided in FIG. 4 is configured substantially similarly as described in regard to FIGS. 1-3. However, in FIG. 4, the strut 105 of the nozzle assembly 120 is disposed at an acute nozzle angle 107 relative to the reference radial plane 13 extended from the axial centerline 12 of the engine 10. In various embodiments, the nozzle angle 107 is between approximately zero degrees and approximately 85 degrees relative to the axial centerline 12 of the engine 10. In still various embodiments, the compressor airfoil 111 defines an exit angle 94 relative to the radial plane 13 extended from the axial centerline 12. The exit angle 94 is defined from a trailing edge 112 of the compressor airfoil 111.

In one embodiment, a sum of the exit angle 94 from the compressor airfoil 111 and the nozzle angle 107 of the strut 105 is between approximately zero degrees and approximately 85 degrees relative to the radial plane 13. For example, zero degrees relative to the radial plane 13 is along the radial direction from the axial centerline 12. In another embodiment, the compressor airfoil 111 defines the exit angle 94 within approximately 20 degrees of the nozzle angle 107.

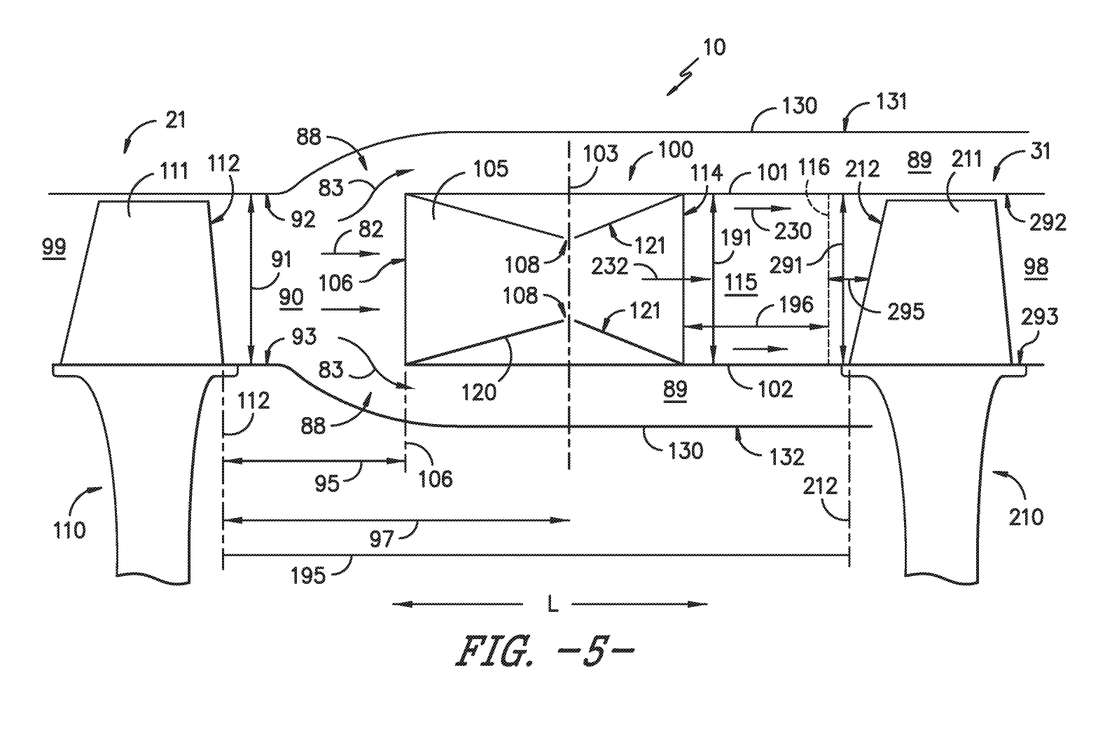

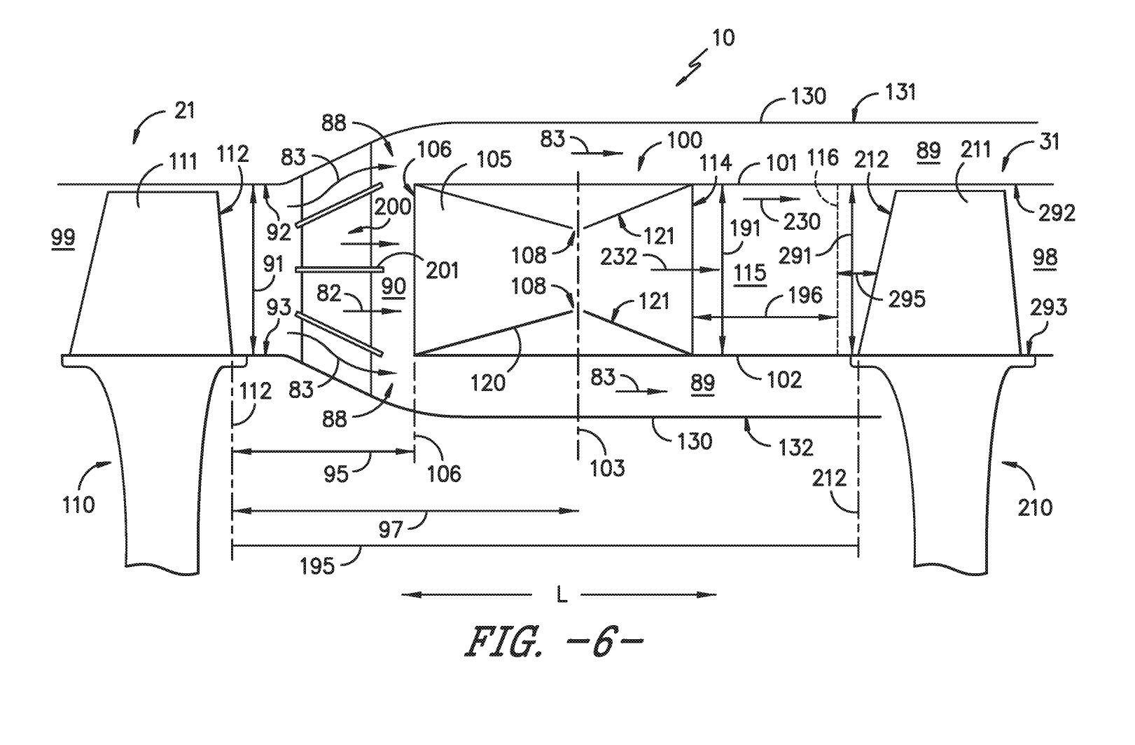

Referring still to FIG. 4, various embodiments of the turbine rotor 210 includes a turbine airfoil 211 disposed downstream of the RDC system 100 in direct fluid communication with the detonation chamber 115. For example, the engine 10 may define the turbine section 31 (FIG. 1) as obviating a turbine nozzle or vane assembly defined between a combustion or detonation chamber exit 116 (shown in FIGS. 5-6, i.e., the downstream end of the detonation chamber 115) and the upstream-most turbine rotor 210.

Referring now to FIGS. 5-6, exemplary embodiments of the compressor rotor 110, the RDC system 100, and the turbine rotor 210 of the engine 10 are generally provided. The embodiments provided in FIGS. 5-6 are configured substantially similarly as shown and described in regard to FIGS. 1-4. Referring now to FIGS. 4-6, the turbine airfoil 211 defines a leading edge 212 adjacent to the detonation chamber exit 116 of the detonation chamber 115. In one embodiment, the core flowpath 90 defines a turbine radial distance 291 at the turbine rotor 210 between an outer turbine radius 292 at the turbine rotor 210 and an inner turbine radius 293 at the turbine rotor 210. For example, the turbine radial distance 291 is defined at the leading edge 212 of the turbine airfoil 211. In various embodiments, the leading edge 212 of the turbine airfoil 211 defines a turbine lengthwise distance 295 from the detonation chamber exit 116 equal to or less than approximately five times the turbine radial distance 291 of the core flowpath 90. In one embodiment, the leading edge 212 of the turbine airfoil 211 defines the lengthwise distance 295 from the detonation chamber exit 116 equal to or less than approximately three times the turbine radial distance 291. In still another embodiment, the leading edge 212 of the turbine airfoil 211 defines the lengthwise distance 295 from the detonation chamber exit 116 equal to or less than approximately two times the turbine radial distance 291 of the core flowpath 90. In still yet another embodiment, the leading edge 212 of the turbine airfoil 211 defines the lengthwise distance 295 from the detonation chamber exit 116 approximately equal to the turbine radial distance 291 of the core flowpath 90.

Referring still to FIGS. 4-6, the RDC system 100 defines a radial gap 191 at the detonation chamber 115 between the outer wall 101 and the inner wall 102. The strut 105 defines a downstream end 114 defined adjacent to the detonation chamber 115. The RDC system 100 further defines a detonation chamber length 196 between the downstream end 114 and the detonation chamber exit 116. In one embodiment, the detonation chamber length 196 is equal to or less than approximately five times the radial gap 191. In another embodiment, the detonation chamber length 196 is equal to less than approximately three times the radial gap 191. In still another embodiment, the detonation chamber length 196 is equal to less than approximately the radial gap 191.

In still various embodiments of the engine 10, the trailing edge 112 of the compressor rotor 110 and the leading edge 212 of the turbine rotor 210 defines a lengthwise distance 195 equal to or less than approximately nine times the radial gap 191. In one embodiment, the trailing edge 112 of the compressor rotor 110 and the leading edge 212 of the turbine rotor 210 defines the lengthwise distance 195 equal to or less than approximately five times the radial gap 191.

Referring back to FIG. 4, the turbine airfoil 211 of the turbine rotor 210 defines a turbine exit angle 96 relative to the reference radial plane 13. In various embodiments, the turbine exit angle 96 is between approximately zero and approximately 85 degrees. In one embodiment, the turbine exit angle 96 is within approximately 20 degrees of the nozzle angle 107 of the strut 105 relative to the reference radial plane 13.

The strut 105 defined at the acute nozzle angle 107 disposes the flow of fuel/oxidizer mixture 232 (shown in FIGS. 5-6) along the circumferential direction C. The detonation wave 230 of hot gases, shown schematically by arrows 231, produced from the fuel/oxidizer mixture 232 approaches the turbine airfoil 211 at an acute angle 85 relative to the reference radial plane 13. The acute angle of the strut 105, the turbine airfoil 211, or combinations thereof, enable obviating a turbine nozzle or turbine vane of the turbine section 31 (FIG. 1).

Referring again to FIGS. 5-6, in various embodiments, the engine 10 further defines a pressure vessel 130 surrounding the outer wall 101 and the inner wall 102 of the RDC system 100. A cooling passage 89 is defined between the pressure vessel 130 and the RDC system 100. In one embodiment, the pressure vessel 130 includes an outer vessel wall 131 and an inner vessel wall 132 each extended along the lengthwise direction L and surrounding the RDC system 100. As such, each vessel wall 131, 132 may define a generally cylindrical structure. The outer vessel wall 131 and the inner vessel wall 132 are each extended along the lengthwise direction around the outer wall 101 and the inner wall 102 of the RDC system 100.

In still another embodiment, the cooling passage 89 is in fluid communication with the core flowpath 90 between the trailing edge 112 of the compressor airfoil 111 and the strut 105. A flow of oxidizer, shown schematically by arrows 83, is provided from the core flowpath 90 and the cooling passage 89 via an opening 88 in at least one of the outer wall 101 or the inner wall 102 of the RDC system 100.

Referring now to FIG. 6, in one embodiment, the engine 10 may further include a guide vane 200 disposed between the compressor rotor 110 and the RDC system 100 along the lengthwise direction L. The guide vane 200 includes a fin 201 extended at least partially along a circumferential direction to dispose the flow of oxidizer 83 into the RDC system 100 at least partially along the circumferential direction relative to the axial centerline 12. In one embodiment, one or more of the fins 201 is disposed at an acute angle relative to the lengthwise direction L such as to dispose the flow of oxidizer 82 to the cooling passage 89 (such as generally shown by arrows 83) defined at least partially around the RDC system 100.

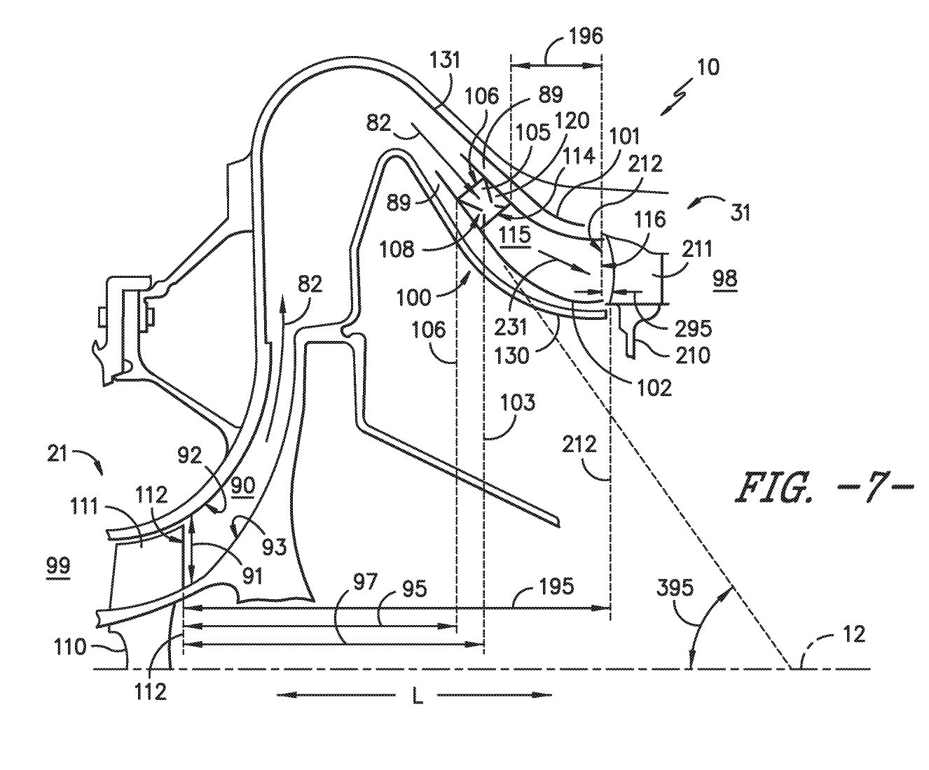

Referring now to FIG. 7, another exemplary embodiment of the engine 10 including the compressor rotor 110 and the RDC system 100 is generally provided. The embodiment of the engine 10 shown and described in regard to FIG. 7 is configured substantially similarly as shown and described in regard to FIGS. 1-6. However, in FIG. 7, the engine 10 defines, at least in part, a centrifugal-flow compressor section 21 in direct fluid communication with the RDC system 100. As such, the core flowpath 90 downstream of the compressor airfoil 111 contours along a radial direction relative to the axial centerline 12. In various embodiments, the RDC system 100 may be disposed radially outward (such as generally provided in FIG. 7) or inward of the compressor airfoil 111.

Referring still to FIG. 7, the RDC system 100 may be disposed at an acute angle 395 relative to the axial centerline 12. In various embodiments, the angle 395 at which the RDC system 100 is disposed relative to the axial centerline 12 is between approximately zero degrees and approximately 85 degrees. As such, the upstream end 106 of the strut 105 may further define a complimentary angle relative to the axial centerline 12. Still further, one or more of the fuel injection opening 108 may be disposed further forward or upstream along the lengthwise direction L than another of the fuel injection opening 108. As described generally in regard to FIG. 2, the first lengthwise distance 97 from the trailing edge 112 of the compressor airfoil 111 to the fuel injection opening 108 may be understood as from a downstream-most point of the trailing edge 112 of the compressor airfoil 111 to an upstream-most fuel injection opening 108.

Referring to FIGS. 1-7, it should further be appreciated that the trailing edge 112 of the compressor airfoil 111, the leading edge 212 of the turbine airfoil 211, the upstream end 106 and downstream end 114 of the strut 105 of the RDC system 100, or the detonation chamber exit plane 116 may each define a contour such as to dispose one or more portions of each feature (e.g., 112, 212, 106, 114, 116, etc.) differently along the lengthwise direction L relative to itself. As such, distances (e.g., distances 91, 95, 97, 195, 196, 295, etc.) described herein may alter based on a portion of the feature from which the distance is measured. However, differences along the lengthwise direction L of each feature (e.g., 112, 212, 106, 114, 116, etc.) should be considered as within the approximating language as used herein. As such, for example, the first lengthwise distance 97 from the trailing edge 112 of the compressor airfoil 111 to the fuel injection opening 108 includes contours of the trailing edge 112 more or less forward or aft along the lengthwise direction L.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A turbine engine, comprising:
a compressor rotor comprising a compressor airfoil, wherein the compressor airfoil defines a trailing edge, and wherein the compressor airfoil is disposed within a core flowpath of the turbine engine, and further wherein the core flowpath defines a radial distance between an outer radius and an inner radius at the compressor rotor; and
a rotating detonation combustion (RDC) system comprising an outer wall and an inner wall, wherein the outer wall and the inner wall are each extended along a lengthwise direction and defining a detonation chamber therebetween, and wherein the RDC system further comprises a strut defined along a radial direction, the strut defining a nozzle assembly, wherein the nozzle assembly defines a fuel injection opening providing a flow of fuel to the detonation chamber, and wherein the compressor rotor provides a flow of oxidizer in direct fluid communication to the nozzle assembly of the RDC system.

2. The turbine engine of claim 1, wherein the fuel injection opening is defined at a first lengthwise distance from the trailing edge of the compressor airfoil equal to or less than approximately nine times the radial distance of the core flowpath.

3. The turbine engine of claim 2, wherein the strut of the RDC system defines an upstream end defined at a second lengthwise distance less than the first lengthwise distance.

4. The turbine engine of claim 1, wherein the radial distance of the core flowpath is defined approximately at the trailing edge or downstream of the compressor airfoil.

5. The turbine engine of claim 1, wherein the compressor rotor defines a downstream-most rotor of a compressor section of the turbine engine proximate to the RDC system.

6. The turbine engine of claim 1, wherein the strut is disposed at an acute nozzle angle relative to a reference radial plane extended from an axial centerline of the turbine engine.

7. The turbine engine of claim 6, wherein the nozzle angle is between approximately zero degrees and approximately 85 degrees relative to the axial centerline of the turbine engine.

8. The turbine engine of claim 6, wherein the compressor airfoil defines an exit angle relative to the axial centerline of the turbine engine, and wherein a sum of the exit angle and the nozzle angle is between approximately zero degrees and approximately 85 degrees.

9. The turbine engine of claim 8, wherein the compressor airfoil defines the exit angle within approximately 20 degrees of the nozzle angle.

10. The turbine engine of claim 1, further comprising:
a pressure vessel surrounding the outer wall and the inner wall of the RDC system, wherein a cooling passage is defined between the pressure vessel and the RDC system.

11. The turbine engine of claim 10, wherein the pressure vessel comprises an outer vessel wall and an inner vessel wall, wherein the outer vessel wall and the inner vessel wall are each extended along the lengthwise direction around the outer wall and the inner wall of the RDC system.

12. The turbine engine of claim 10, wherein the cooling passage is in fluid communication with the core flowpath between the trailing edge of the compressor airfoil and the strut, and wherein a flow of oxidizer is provided from the core flowpath and the cooling passage via an opening in at least one of the outer wall or the inner wall.

13. The turbine engine of claim 1, further comprising:
a turbine rotor comprising a turbine airfoil disposed downstream of the RDC system in direct fluid communication with the detonation chamber.

14. The turbine engine of claim 13, wherein the core flowpath defines a turbine radial distance at the turbine rotor between an outer turbine radius at the turbine rotor and an inner turbine radius at the turbine rotor, and further wherein the leading edge of the turbine airfoil defines a turbine lengthwise distance from the detonation chamber exit equal to or less than approximately five times the turbine radial distance of the core flowpath.

15. The turbine engine of claim 13, wherein the RDC system defines a radial gap between the outer wall and the inner wall, and further wherein the strut defines a downstream end defined adjacent to the detonation chamber, and wherein the RDC system defines a detonation chamber length between the downstream end and the detonation chamber exit equal to or less than approximately five times the radial gap.

16. The turbine engine of claim 15, wherein the trailing edge of the compressor rotor and the leading edge of the turbine rotor define a lengthwise distance equal to or less than approximately nine times the radial gap.

17. The turbine engine of claim 13, wherein the turbine airfoil of the turbine rotor defines a turbine exit angle relative to a reference radial plane extended from an axial centerline of the turbine engine, and wherein the turbine exit angle is between approximately zero and approximately 85 degrees.

18. The turbine engine of claim 17, wherein the turbine exit angle is within approximately 20 degrees of a nozzle angle relative to the reference radial plane.

19. The turbine engine of claim 1, further comprising:
a guide vane disposed between the compressor rotor and the RDC system along the lengthwise direction, wherein the guide vane comprises a fin extended at least partially along a circumferential direction to dispose a flow of oxidizer to the RDC system.

20. The turbine engine of claim 19, wherein one or more of the fins is disposed at an acute angle relative to the lengthwise direction such as to dispose a flow of oxidizer to a cooling passage defined at least partially around the RDC system.
